(19) United States
(12) Patent Application Publication
(10) Pub. No.: US 2013/0284796 A1
(43) Pub. Date: Oct. 31, 2013

(54) SYSTEM IN PACKAGE MODULE ASSEMBLY

(71) Applicants: Mohan R. Nagar, Cupertino, CA (US); Mudasir Ahmad, San Jose, CA (US)

(72) Inventors: Mohan R. Nagar, Cupertino, CA (US); Mudasir Ahmad, San Jose, CA (US)

(73) Assignee: Cisco Technology, Inc., San Jose, CA (US)

(21) Appl. No.: 13/455,908

(22) Filed: Apr. 25, 2012

(51) Int. Cl. B23K 31/02; B23K 37/00

(52) U.S. Cl. 228/199; 228/44.7

(57) ABSTRACT

In one implementation, a system in package assembly process includes attaching a cladding to a substrate to keep the substrate flat while components are soldered onto the substrate. The cladding may include a supporting member and a clamping member, and the substrate may be received between the clamping member and the supporting member. The clamping member may have a plurality of openings formed therein, and the components may be positioned on the substrate within at least one of the plurality of openings. A predetermined pressure may be applied to the clamping member and/or supporting to keep the substrate flat.

### FIELD

The present embodiments relate to system in package module assembly.

### BACKGROUND

A system in package module includes various components, including one or more integrated circuit devices, assembled onto a substrate to form a functional electronic system in a compact module. During assembly of system in package modules, heating processes such as reflow soldering and baking or curing are used to attach and connect the various components to the substrate. The heat can cause the substrate to warp, which compromises connections between the components and the substrate.

### BRIEF DESCRIPTION OF THE DRAWINGS

FIG. 1 illustrates a top view of an embodiment of a system in package module.

FIG. 2 illustrates a section view of the system in package module of FIG. 1.

FIG. 3 illustrates a logical diagram of an embodiment of an assembly process for a system in package module.

FIG. 4 illustrates a top view of an embodiment of a cladding for assembling a system in package module.

FIG. 5 illustrates a section view of the cladding of FIG. 4.

FIG. 6 illustrates a logical diagram of another embodiment of an assembly process for a system in package module.

FIG. 7 illustrates a top view of another embodiment of a cladding for assembling a system in package module.

FIG. 8 illustrates a section view of the cladding of FIG. 7.

FIG. 9 illustrates a logical diagram of an embodiment of an assembly process for a system in package module.

FIG. 10 illustrates another embodiment of a cladding for assembling a system in package module.

FIG. 11 illustrates another embodiment of a system in package module.

FIG. 12 illustrates a top view and a section view of an embodiment of a cladding for assembling multiple system in package modules.

### DETAILED DESCRIPTION

### Overview

In one aspect a method comprises removably attaching a cladding to a substrate for assembly of a system in package module. The substrate has a first surface and a second surface. The cladding includes a supporting member configured to receive the second surface of the substrate thereon, and a clamping member configured to receive the substrate between the clamping member and the supporting member so that the substrate is parallel to the supporting member. The clamping member may have a plurality of openings formed therein. The method may also include soldering an integrated circuit chip onto the first surface of the substrate after the cladding is removably attached to the substrate. The integrated circuit chip may be positioned within at least one of the plurality of openings. The method may further include applying a predetermined pressure on the clamping member causing the clamping member to maintain as flat the substrate during and after soldering of the integrated circuit chip, and removing the cladding from the substrate after the integrated circuit chip is mounted on the substrate.

### EXAMPLE EMBODIMENTS

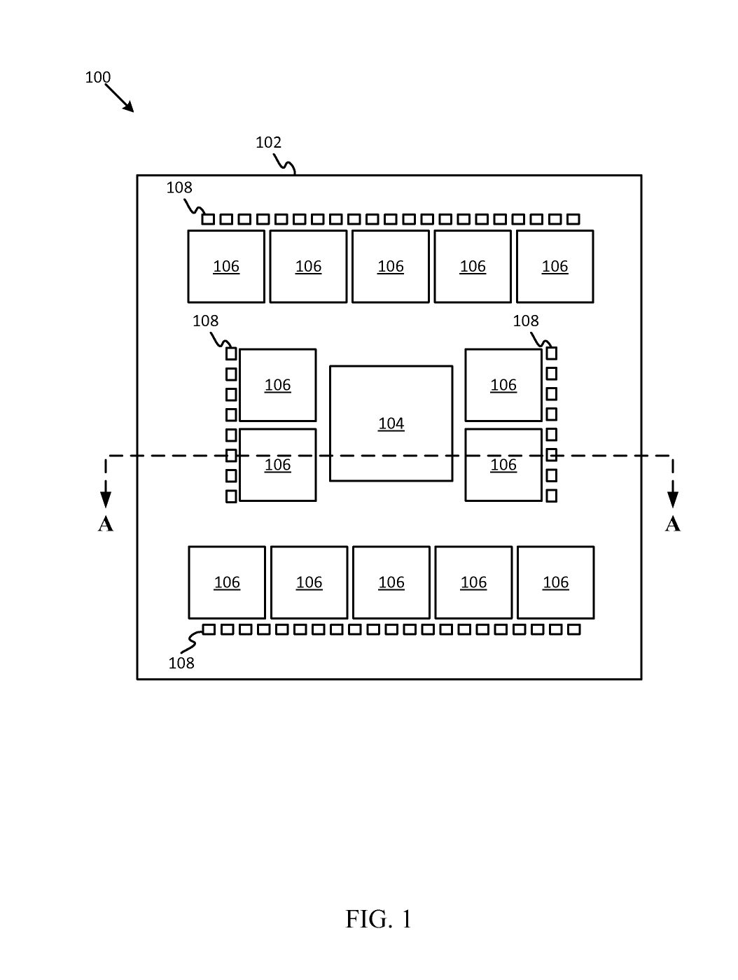

FIG. 1 illustrates a top view of an embodiment of a system in package module. The system in package module 100 includes a substrate 102, an integrated circuit 104, memory chips 106, and passive components 108. The substrate 102 may be a circuit board, such as a printed circuit board formed from organic materials. The integrated circuit chip 104 may be an application specific integrated circuit chip, such as a chip including a microprocessor, a field programmable gate array (FPGA), any stacked multi-functional semiconductor device, or any other semiconductor-based circuitry that is customized for a particular use. The memory chips 106 may be random access memory, static or dynamic random access memory, or any other type of memory that may include a packaged or bare silicon die. The passive components 108 may include one or more capacitors, diodes, inductors, resistors and/or any other device that is not powered in order to operate

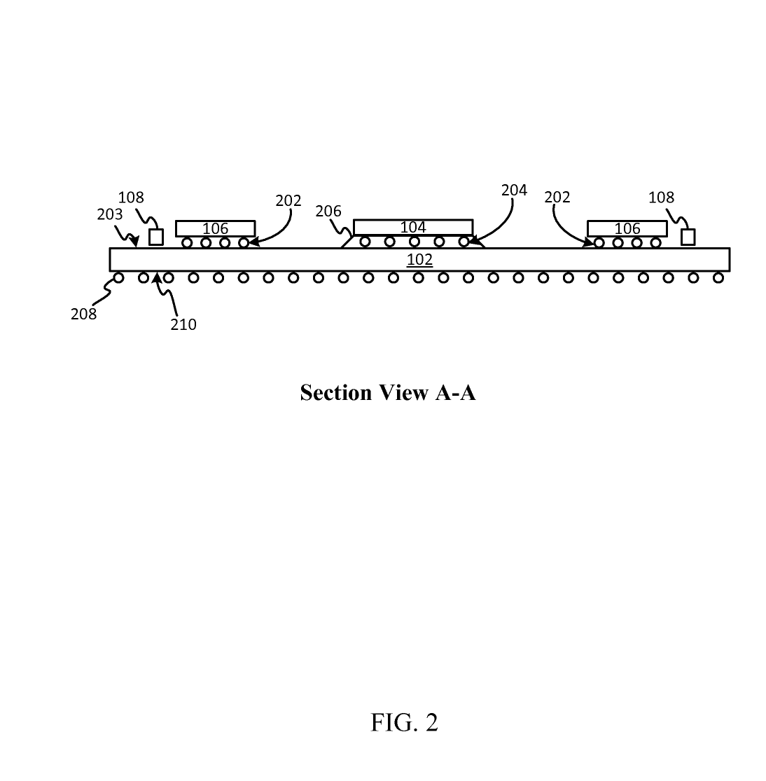

FIG. 2 illustrates a section view of the system in package module of FIG. 1. As shown in FIG. 1, the system in package module 100 includes a substrate 102, an integrated circuit 104, memory chips 106, and passive components 1008. The system in package module 100 may also include solder 202, such as a solder paste, solder wire, solder balls, solder pins, solder foil or any other form of fusible metal alloy with a low melting point, such as a copper or tin alloy, that may be used to attach the memory chips 106 to a first surface 203 of the substrate 102 and solder 204, such as a solder paste, solder wire, solder balls, solder pins, solder foil or any other form of fusible metal alloy with a low melting point, such as a copper or tin alloy, that may be used to attach the integrated circuit chip 104 to the substrate 102. The system in package module 100 may further include an underfill 206 to fill gaps between the integrated circuit chip 104 and the substrate 102, and solder 208, such as in a ball grid array, soldered onto a second surface 210 of the substrate 102. The underfill 206 may be, for example, amine, phenol based, phase change material. In one implementation, the first surface 203 and the second surface 210 may be oriented as the top and bottom surface, respectively, of the substrate 102. In other implementations, orientation of the first surface 203 and the second surface 210 may vary according to the orientation of the substrate. For example, the substrate may be oriented diagonally or vertically during the system in package assembly process. Accordingly, as used herein, the terms “top” and “bottom” should not be construed as limiting the embodiments of the invention to any particular orientation.

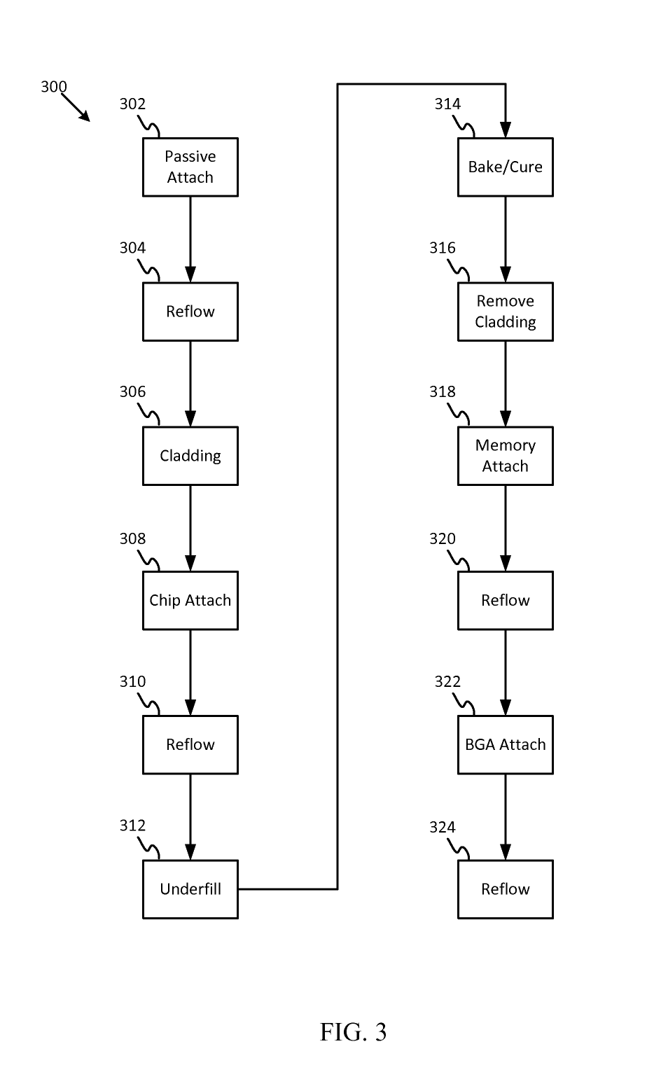

FIG. 3 illustrates a logical diagram of an embodiment of an assembly process for a system in package module. The process 300 may begin by mounting a passive component onto a substrate by positioning the passive component onto the substrate at block (or step) 302 and reflow soldering the passive component to the substrate at block 304. Then, a cladding is attached to the substrate at block 306. Next, an integrated circuit chip is mounted to the substrate by positioning the integrated circuit chip on the substrate at block 308 and reflow soldering the integrated circuit chip onto the substrate at block 310. During the reflow soldering at block 310, the substrate is heated to a predetermined temperature. Then, an underfill is deposited between the substrate and the integrated circuit chip at block 312 and the underfill is heated, e.g., baked or cured, at block 314 to allow the underfill to flow and join the integrated circuit chip to the substrate. The substrate may be cooled to another predetermined temperature, such as room temperature, before the cladding is removed at block 316. The temperature may be monitored by a temperature gauge, or the substrate may be cooled for a predetermined period of time. Then, a memory chip is mounted on the substrate by positioning the memory chip on the substrate at block 318 and reflow soldering the memory chip onto the substrate at block 320. The process 300 may also include attaching a ball grid array to the second surface of the substrate at block 322 and reflow soldered at block 324 onto the substrate. Alternatively, a pin grid array may be attached to the substrate.

In one implementation, the process 300 may be an automated process in which one or more robotic arms, or other programmable machines, perform all of the steps. In another implementation, the process 300 may be a semi-automated process in which a robotic arm, or other programmable machine, performs only some of the steps.

Reflow soldering at block 304, 310, 320 or 324 may be a known process for attaching components to a substrate. The process includes applying a solder paste to one or more components to be attached to a substrate, heating the substrate and components for a predetermined time and to a predetermined temperature that is high enough to allow a solder to melt and flow between the substrate and component, thereby joining component to the substrate. The heating may involve passing the components and substrate through a reflow over or under an infrared lamp or by other known methods of soldering, such as thermo compression bonding. The predetermined time and predetermined temperature may vary at blocks 304, 310, 320 and 324 and may depend on factors such as the material of the solder, the material of the substrate and the material of the components.

In other embodiments of the system in package module assembly process, the steps may be performed in a different order. For example, the cladding may be attached and removed at different stages of the process. In an embodiment, the process may include attaching the cladding to the substrate 102 before the passive components 108 are attached and reflow soldered to the substrate 102. Alternatively, or in addition, the cladding may remain attached to the substrate until after the memory chip 106 is attached and reflow soldered to the substrate 102. When the cladding is attached to the substrate 102 before the passive components 108 are attached and reflow soldered, the cladding may include additional openings to allow the passive components to be positioned on the substrate 102. When the cladding remains attached to the substrate 102 while the memory chips 106 are attached and reflow soldered, the cladding may include additional openings to allow for the memory chips 106 to be positioned on the substrate while the cladding is still attached.

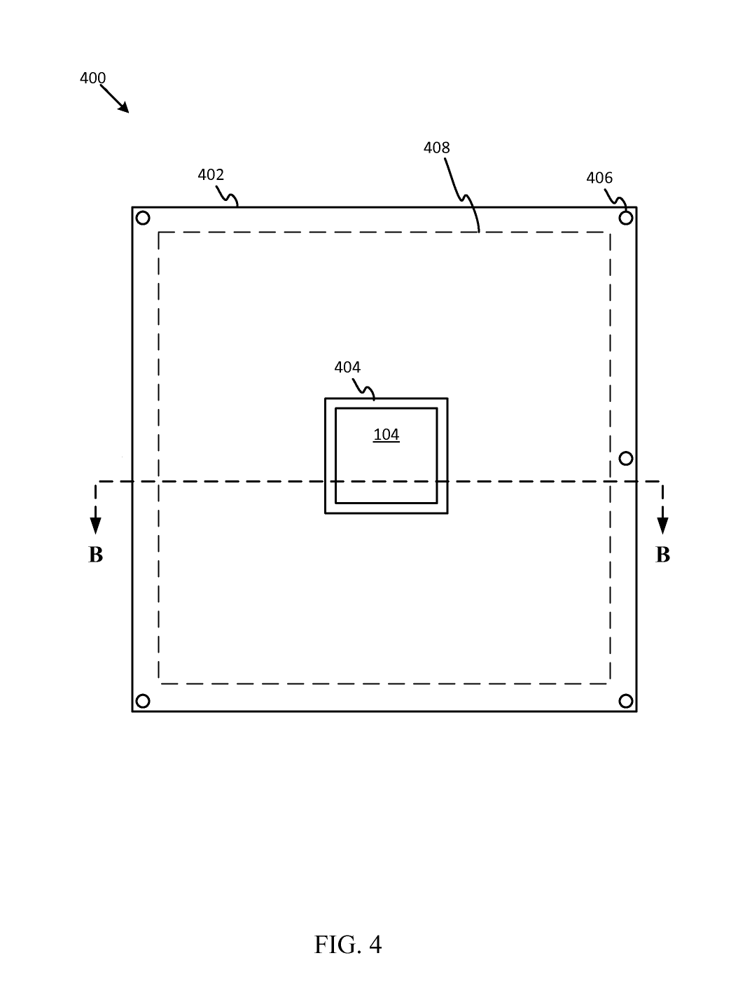

FIG. 4 illustrates a top view of an embodiment of a cladding for assembling a system in package module. Similar to the system in package assembly process of FIG. 3, the cladding 400 may be attached to the substrate 306 before the integrated circuit chip is attached 308. The cladding 400 may include a clamping member 402, which is positioned to be in contact with a first surface of the substrate. The clamping member 402 may be a planar surface, such as a plate formed of rigid material. The material of the clamping member may vary depending on process operation conditions, such as temperature and pressure. Suitable materials for the clamping member may include, for example, metal, plastic, tool steel, or any other commercially available rigid material can withstand thermal excursion handling. The clamping member 402 may include an opening 404, which may be sized to fit a component, such as the integrated circuit chip 104.

The cladding may be removed at block 316 before other components, such as memory chips 106, are attached. The cladding may also include positioning holes 406 in the top clamping member 402 and the supporting member. Pins, screws or posts may be inserted into the positioning holes 406 to keep the clamping member 402 aligned with the supporting member while the cladding is attached to the substrate 102 during the system in package module assembly process

The clamping member 402 may also include a boundary area 408 that encompasses the substrate. The boundary area 408 may be substantially the same size as the clamping member 402, and may lie within the perimeter of the clamping member 402. Alternatively, the boundary area 408 may coincide with the perimeter of the clamping member 402. The shape and size of the boundary area 408 may vary with the shape and size of the clamping member 402 and/or the shape and size of the substrate 102. In other examples, the clamping member 402 may be any number of separate independent members, with at least some of the members including positioning holes.

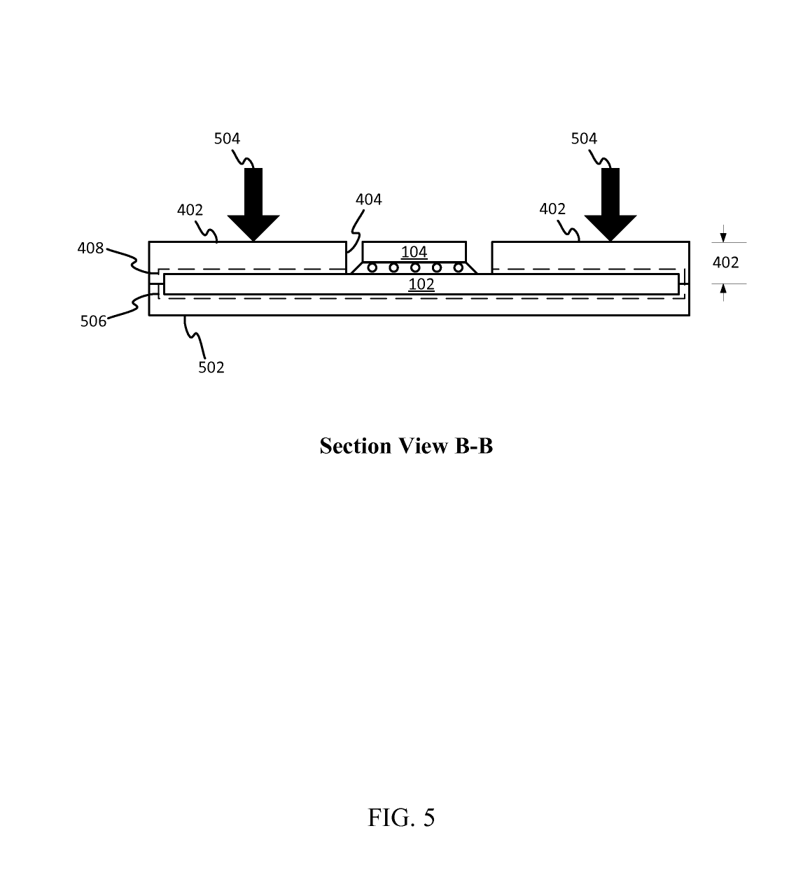

FIG. 5 illustrates a section view of the cladding of FIG. 4. A supporting member 502 of the cladding may hold the substrate while the clamping member 402 is placed on the substrate 102. The supporting member 502 may be a planar surface, such as a metal plate. The material of the supporting member may vary depending on process operation conditions, such as temperature and pressure. Suitable materials for the supporting member 502 may include, for example, metal, plastic, tool steel, or any other commercially available rigid material that can withstand thermal excursion and handling. An integrated circuit chip may be positioned in the opening 404 of the clamping member 402. The clamping member 402 may have a thickness 504 to match the height of components attached to the substrate. A pressure or force 504 may be applied to the clamping member 402 to keep the substrate 102 flat while the integrated circuit chip 104 is being attached and reflow soldered onto the substrate, for example, at block 310 of process 300. Alternatively or additionally, pressure may be applied to the supporting member 502 to keep the substrate flat. The force or pressure may be applied using a press, motor, hydraulics, or any other suitable mechanism. In this way, the cladding may reduce warpage in the substrate caused by heat from the reflow soldering. Then, underfill 206 may be deposited between the substrate 102 and the integrated circuit chip 104, and the components are cured to allow the underfill 206 to fill remaining gaps or voids between the integrated circuit chip 104 and the substrate 102.

The supporting member 502 may also include a boundary area 506 that encompasses the substrate. The boundary area 506 may be substantially the same size as the supporting member 506, and may lie within the perimeter of the supporting member 502. Alternatively, the boundary area 506 may coincide with the perimeter of the supporting member 502. The shape and size of the boundary area 506 may vary with the shape and size of the supporting member 502 and/or the shape and size of the substrate 102. The boundary area 506 may be substantially the same size and/or shape of the boundary area 406 of clamping member.

In other embodiments, the cladding may be any quadrilateral shape, or any other shape, size, orientation, or configuration. For example, the cladding may have rounded corners, or may have the shape of a circle, oval, triangle, diamond, hexagon, or a non-symmetrical shape. The cladding may include notches or cutouts in any portion of the cladding to reduce the weight, amount of material, and/or cost of the cladding. The shape, size, orientation, and configuration of the cladding may adapt to the shape, size, orientation, and configuration of the substrate and any components attached to the substrate. The type of material used for the cladding may vary depending on operating factors, including, for example: the amount of heat applied to attach components to the substrate, the amount of force or pressure applied to the cladding to keep the substrate flat, the rigidity, size and material of the substrate, and the quantity and size of components attached to the substrate. Openings in the cladding may also vary in shape, size, orientation, and configuration depending on the shape, size, orientation, and configuration of integrated circuit chip, the memory chip, the passive components and any other components to be attached to the substrate.

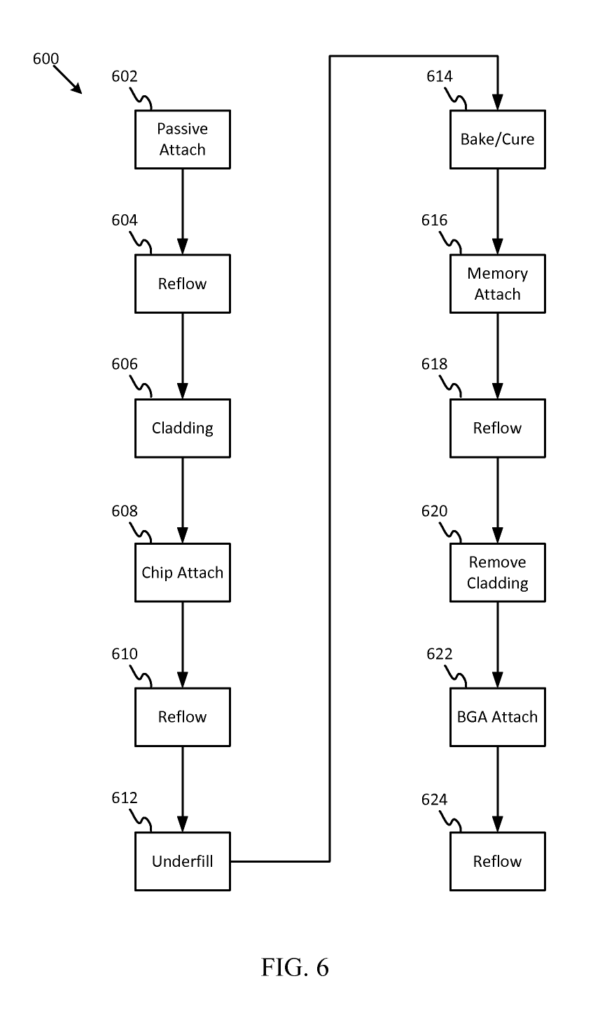

FIG. 6 illustrates a logical diagram of another embodiment of an assembly process for a system in package module. The process 600 may begin by mounting a passive component on the substrate by positioning the passive component on the substrate at block 602 and reflow soldering the passive component to the substrate at block 604. Then, a cladding is attached to the substrate at block 606. Next, an integrated circuit chip is mounted on the substrate by positioning the integrated circuit chip on the substrate at block 608 and reflow soldering the integrated circuit chip onto the substrate at block 610. Then, an underfill is deposited between the substrate and the integrated circuit chip at block 612 and the underfill is heated, e.g., baked or cured, at block 614 to a temperature that allows the underfill to flow and fill gaps between the integrated circuit chip and the substrate. Next, a memory chip is mounted on the substrate 102 by positioning the memory chip on the substrate at block 616 and reflow soldering the memory chip onto the substrate at block 618. During the reflow soldering at block 618, the substrate is heated to a predetermined temperature. Before the cladding is removed at block 629, the substrate may be cooled to another predetermined temperature. After the cladding is removed at block 620, a ball grid array 208 may be attached to the second surface of the substrate at block 622 and reflow soldered at block 624 onto the substrate. Alternatively, a pin grid array may be attached to the substrate. In other implementations, the cladding may be removed after the integrated circuit chip 104 is reflow soldered and before the memory chip 108 is positioned on the substrate.

In one implementation, the process 600 may be an automated process in which the robotic arm, or other programmable machine, performs all of the steps. In another implementation, the process 600 may be a semi-automated process in which a robotic arm, or other programmable machine, performs only some of the steps.

Reflow soldering at block 604, 610, 618 or 624 may be a known process for attaching components to a substrate. The process includes applying a solder paste to one or more components to be attached to a substrate, heating the substrate and components for a predetermined time and to a predetermined temperature that is high enough to allow a solder to melt and flow between the substrate and component, thereby joining component to the substrate. The heating may involve passing the components and substrate through a reflow over or under an infrared lamp or by other known methods of soldering. The predetermined time and predetermined temperature may vary at blocks 604, 610, 618 and 624, and may depend on factors such as the material of the solder, the material of the substrate and the material of the components.

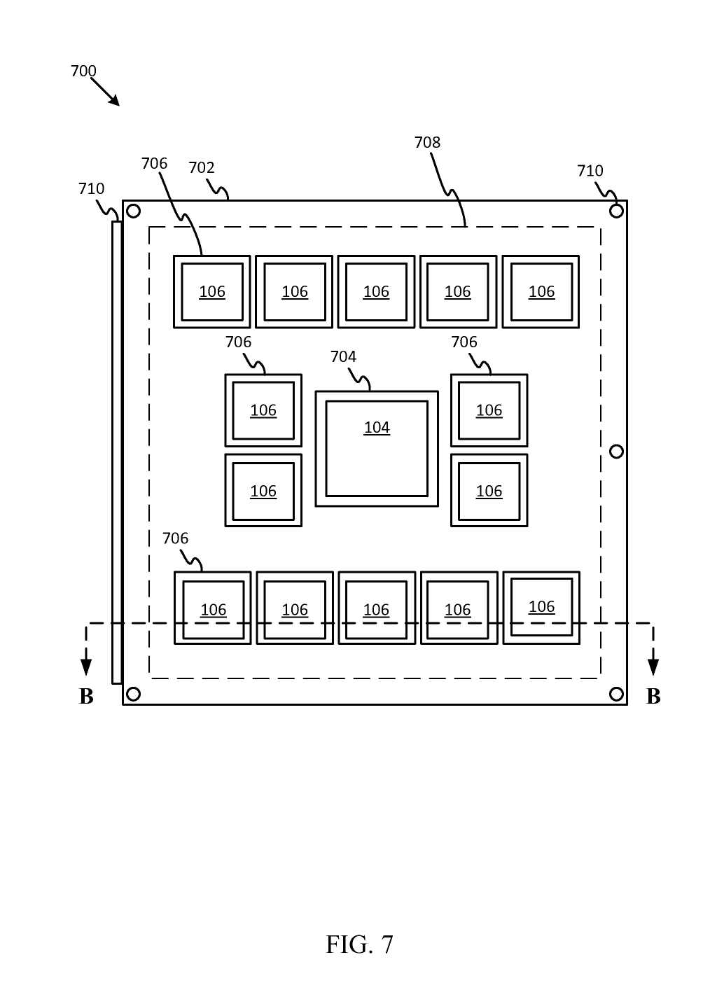

FIG. 7 illustrates a top view of another embodiment of a cladding for assembling a system in package module. A cladding 700 may be used, for example, in a system in package module assembly process, similar to the process 600 of FIG. 6. The cladding 700 may include a clamping member 702, which includes a plurality of openings 704, 706. The openings may be sized to fit components, including, for example, memory chips 106 and integrated circuit chips 104, that are assembled onto a substrate 102 for the system in package module 100. Other embodiments may include fewer, additional, different sized or different shaped openings to accommodate components for a system in package module. The cladding may optionally include a hinge 710 to connect the clamping member 702 of the cladding to a supporting member of the cladding. The cladding may also include positioning holes 710 in the clamping member 702 and the supporting member. Pins, screws or posts may be inserted into the positioning holes 710 to keep the clamping member 702 aligned with the supporting member while the cladding is attached to the substrate 102 during the system in package module assembly process.

The clamping member 702 may be a planar surface, such as a plate formed of rigid material. The material of the clamping member may vary depending on process operation conditions, such as temperature and pressure. Suitable materials for the clamping member may include, for example, metal, plastic, or any other rigid material. The clamping member 702 may also include a boundary area 708 that encompasses the substrate. The boundary area 708 may be substantially the same size as the clamping member 702, and may lie within the perimeter of the clamping member 702. Alternatively, the boundary area 708 may coincide with the perimeter of the clamping member 702. The shape and size of the boundary area 708 may vary with the shape and size of the clamping member 702 and/or the shape and size of the substrate 102. In other examples, the clamping member 702 may be any number of separate independent members, with at least some of the members including positioning holes.

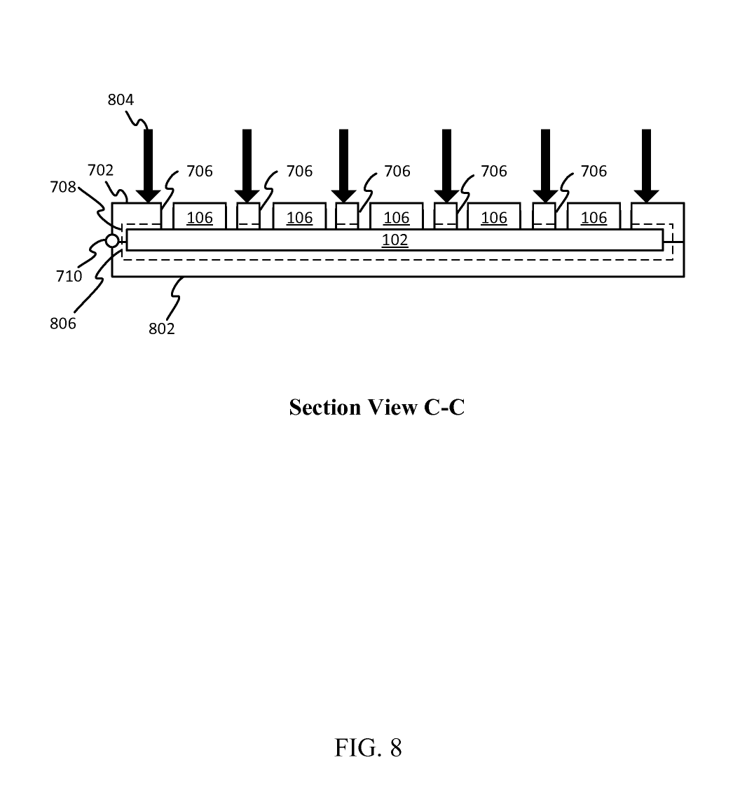

FIG. 8 illustrates a section view of the cladding of FIG. 7. During assembly of the system in package module, the supporting member 802 of the cladding may hold the substrate 102 and be in direct contact with the bottom surface of the substrate 102. The clamping member 702 of the cladding may be positioned on the top surface of the substrate 102. A force 804 may be applied on the clamping member 702 to keep the substrate 102 flat while components such as memory chips 106 and integrated circuit chips 104 are soldered onto the substrate 102, and to reduce overall warpage to the substrate 102. Alternatively or additionally, pressure 804 may be applied to the supporting member 502 to keep the substrate flat. The force or pressure 804 may be applied using a motor, hydraulics or any other mechanism. The cladding keeps the substrate 102 flat while heat is applied to attach the components 106, thereby reducing warpage to the substrate 102. The cladding 700 is positioned to hold the substrate 102 so that components, such as memory chips 106, may be positioned in the openings 706 of the clamping member 702.

The supporting member 802 may also include a boundary area 806 that encompasses the substrate. The boundary area 806 may be substantially the same size as the supporting member 806, and may lie within the perimeter of the supporting member 802. Alternatively, the boundary area 806 may coincide with the perimeter of the supporting member 802. The shape and size of the boundary area 806 may vary with the shape and size of the supporting member 802 and/or the shape and size of the substrate 102. The boundary area 506 may be substantially the same size and/or shape of the boundary area 406 of clamping member.

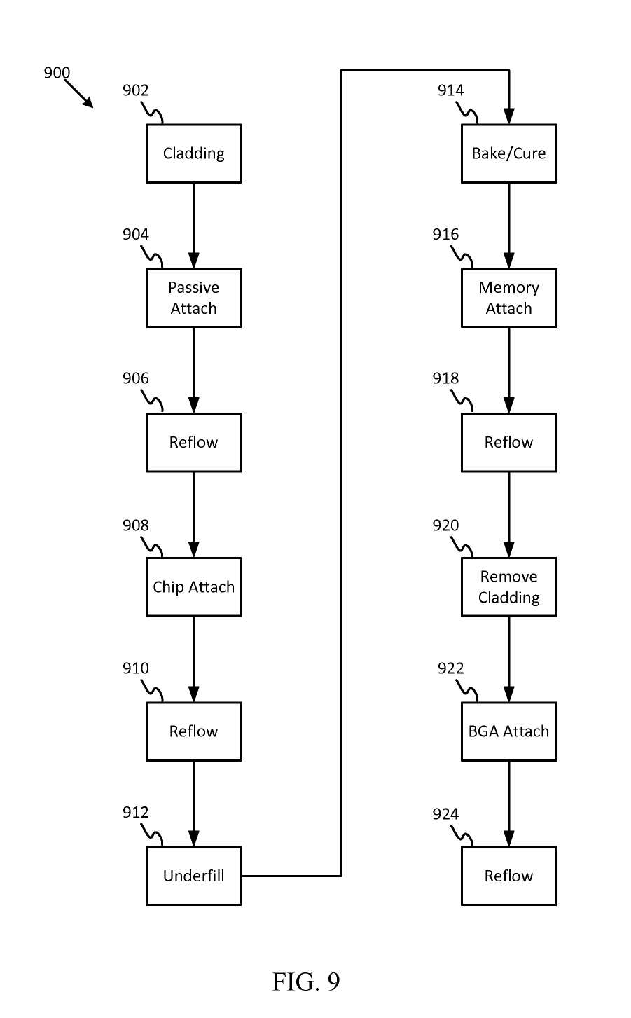

FIG. 9 illustrates a logical diagram of an embodiment of an assembly process for a system in package module. The process 900 may begin by attaching a cladding to the substrate at block 902. Then, a passive component may be mounted on the substrate by positioning at block 904 and reflow soldering at block 906 the passive component to the substrate. Next, an integrated circuit chip is mounted on the substrate by positioning at block 908 and reflow soldering at block 910 the integrated circuit chip onto the substrate. Then, an underfill is deposited between the substrate and the integrated circuit chip at block 912 and the underfill is heated, e.g., baked or cured, at block 914 to a temperature that allows the underfill to flow and fill gaps between the integrated circuit chip and the substrate. Next, a memory chip is mounted on the substrate by positioning at block 916 and reflow soldering at block 918 the memory chip onto the substrate. During the reflow soldering at block 918, the substrate may be heated to a predetermined temperature. Before the cladding is removed at block 920, the substrate may be cooled to another predetermined temperature. After the cladding is removed at block 920, a ball grid array 208 may be attached to the bottom surface of the substrate at block 922 and reflow soldered at block 924 onto the substrate. Alternatively, a pin grid array may be attached to the substrate.

In one implementation, the process 900 may be an automated process in which the robotic arm, or other programmable machine, performs all of the steps. In another implementation, the process 900 may be a semi-automated process in which a robotic arm, or other programmable machine, performs only some of the steps.

Reflow soldering at block 906, 910, 918 or 924 may be a known process for attaching components to a substrate. The process includes applying a solder paste to one or more components to be attached to a substrate, heating the substrate and components for a predetermined time and to a predetermined temperature that is high enough to allow a solder to melt and flow between the substrate and component, thereby joining component to the substrate. The heating may involve passing the components and substrate through a reflow over or under an infrared lamp or by other known methods of soldering. The predetermined time and predetermined temperature may vary at blocks 906, 910, 918 and 924, and may depend on factors such as the material of the solder, the material of the substrate and the material of the components.

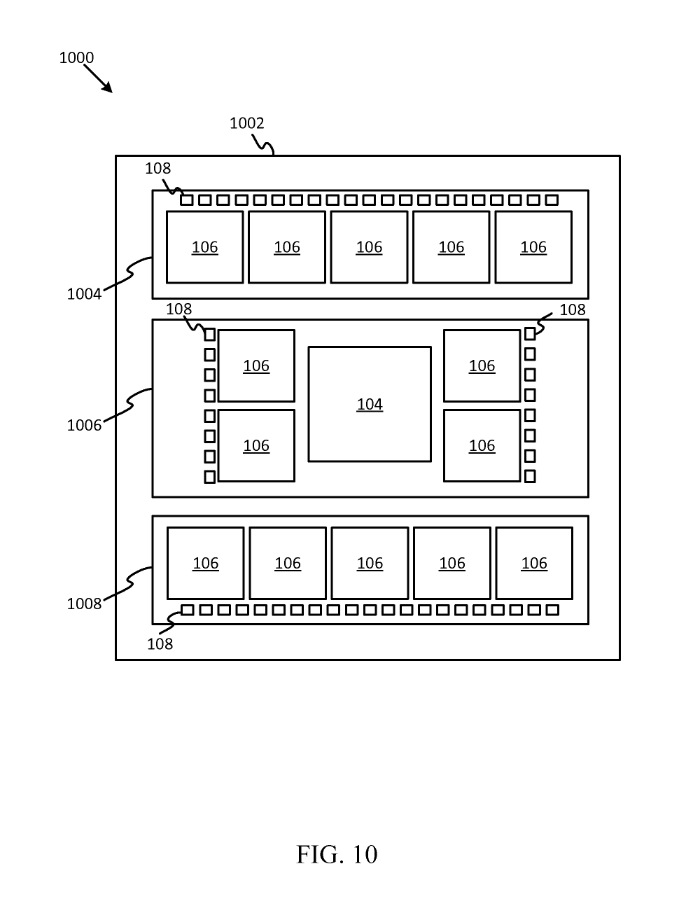

FIG. 10 illustrates another embodiment of a cladding for assembling a system in package module. The cladding 1000 may be used in a system in package module assembly process similar to the process 900 shown in FIG. 9. The cladding 1000 may include a clamping member 1002 with a plurality of openings 1004, 1006, 1008 to allow for placement of various components, such as an integrated circuit chip 104, memory chips 106 and passive components 108. Each opening may allow for placement of multiple components. The cladding 1000 may also include a supporting member, as shown in other embodiments, to hold the substrate 102. A force may be applied to the clamping member 1002 to keep the substrate 102 flat while the components 104, 106, 108 are attached and reflow soldered onto the substrate 102, and to reduce overall warpage to the substrate 102. Alternatively or additionally, pressure may be applied to the supporting member 502 to keep the substrate flat. The force or pressure may be applied using a motor, hydraulics or any other mechanism. In this way, the cladding may reduce warpage in the substrate 102 caused by heat from the reflow soldering. The number of components and particular location of components may determine the length, width and thickness of the cladding 1000 and the size and location of openings 1004, 1006, 1008 in the clamping member 1002 of the cladding 1000.

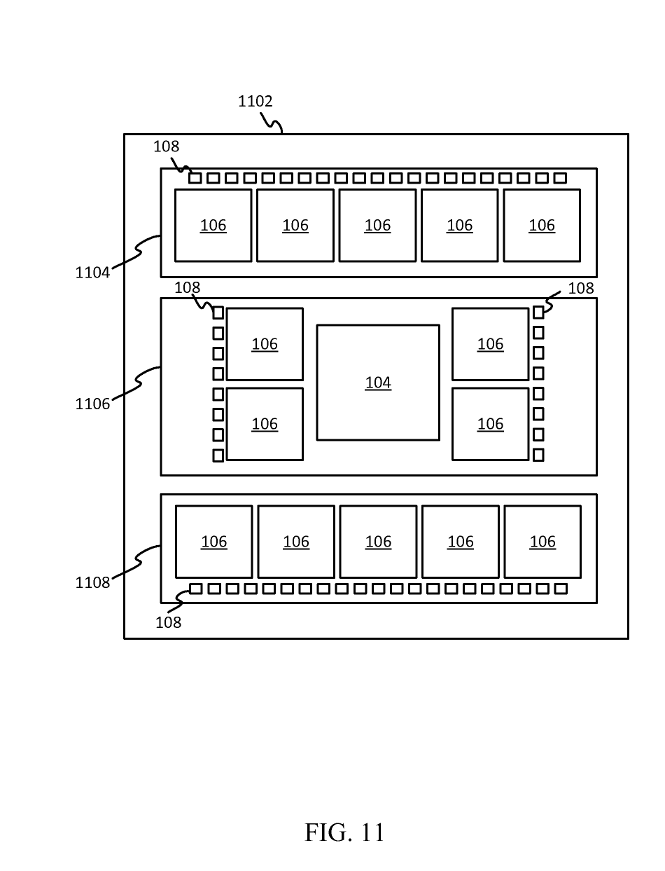

FIG. 11 illustrates another embodiment of a system in package module. The system in package module 1100 may include a stiffener ring 1102 to add rigidity to the substrate 102 and to protect the other components 104, 106, 108 that are attached to the substrate. The stiffener ring 1102 may include a plurality of cavities 1104, 1106, 1108. The stiffener ring 1102 may be positioned on the substrate 102 to allow the components 104, 106, 108 to fit within the cavities 1104, 1106, 1108. The stiffener ring may be attached to the substrate 102 using any suitable adhesive.

In an embodiment, the system in package module assembly process may include a step for attaching a stiffener ring 1102 to the system in package module. The stiffener ring 1102 may be attached after the cladding is removed. Alternatively, the stiffener ring may be attached before a cladding is attached to the substrate 102, or any time after a cladding is attached to the substrate. Multiple components may fit within any of the openings. Alternatively, the openings may be sized and shaped to fit a single component within each opening. The orientation, positioning and number of components shown in FIG. 11 is one example of a system in package module. In other implementations, the components may be arranged in different orientations, positions, and numbers.

In other embodiments, the stiffener ring 1102 may be any quadrilateral shape, or any other shape, size, orientation, or configuration. For example, the stiffener ring 1102 may have rounded corners, or may have the shape of a circle, oval, triangle, diamond, hexagon, or a non-symmetrical shape. The stiffener ring 1102 may include notches or cutouts in any portion of the cladding to reduce the weight, amount of material, and/or cost of the stiffener ring 1102. The shape, size, orientation, and configuration of the stiffener ring 1102 may adapt to the shape, size, orientation, and configuration of the substrate and any components attached to the substrate. The type of material used for the stiffener ring 1102 may vary depending on operating factors, including, for example: the amount of heat applied to attach components to the substrate, the amount of force or pressure applied to the cladding to keep the substrate flat, the rigidity, size and material of the substrate, and the quantity and size of components attached to the substrate. Cavities in the stiffener ring 1102 may also vary in shape, size, orientation, and configuration depending on the shape, size, orientation, and configuration of integrated circuit chip, the memory chip, the passive components and any other components to be attached to the substrate.

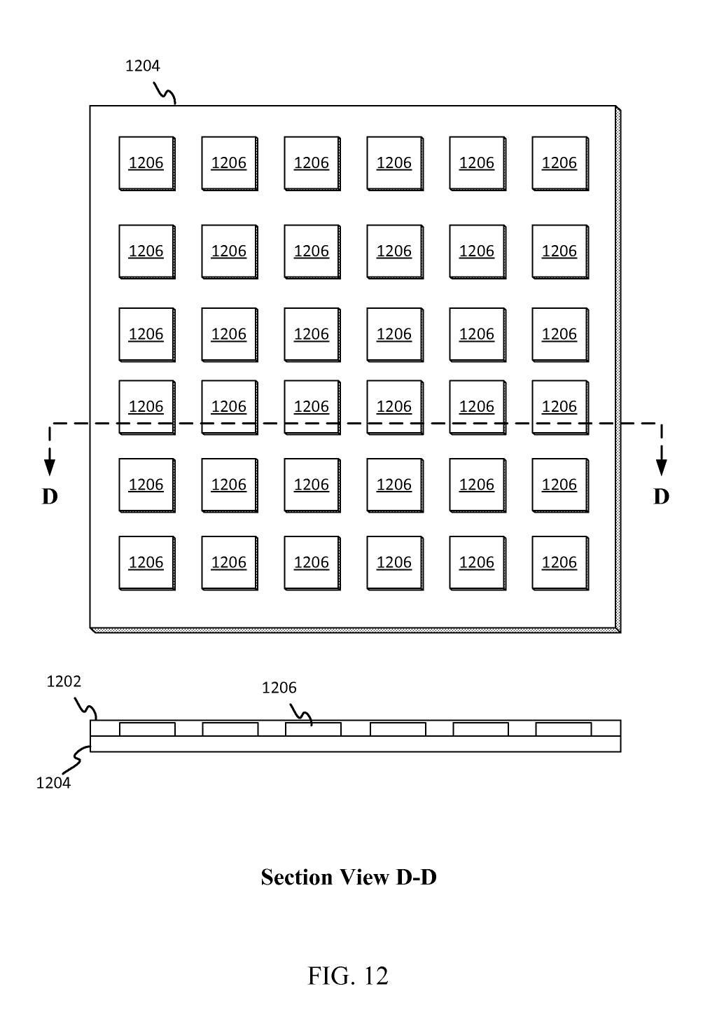

FIG. 12 illustrates a top view and a section view of an embodiment of a cladding for assembling multiple system in package modules. The cladding may include a clamping member 1202 and a supporting member 1204. The supporting member 1204 may be a tray that holds multiple substrates 1206 for assembly. The supporting member 1204 may have indents in the tray surface, and a substrate may be placed in each of the indents. The clamping member 1202 has a pattern, or a grid, of openings to allow for placement of the multiple components for each of the substrates 1206 held by the supporting member 1202. The clamping member 1202 may be hinged to the supporting member 1204. Alternatively, the clamping member 1202 may be positioned onto the substrate and supporting member 1204 during the assembly process.

Various embodiments described herein can be used alone or in combination with one another. The foregoing detailed description has described only a few of the many possible implementations of the present invention. For this reason, this detailed description is intended by way of illustration, and not by way of limitation.

1. A method comprising:
mounting a passive component onto a substrate of a system in package module, the substrate having a first surface and a second surface, the passive component mounted onto the first surface of the substrate;
removably attaching a cladding to the substrate for assembly of the system in package module after the passive component is mounted onto the substrate, wherein the cladding comprises:
a supporting member configured to receive the second surface of the substrate thereon, and
a clamping member configured to receive the substrate between the clamping member and the supporting member so that the substrate is parallel to the supporting member, and the clamping member having a plurality of openings formed therein;
soldering an integrated circuit chip onto the first surface of the substrate after the cladding is removably attached to the substrate, wherein the integrated circuit chip is positioned within at least one of the plurality of openings in the clamping member;
applying a predetermined pressure on an external surface of the clamping member that faces away from the first surface of the substrate causing the clamping member to maintain as flat the substrate during and after soldering of the integrated circuit chip;
removing the cladding from the substrate after the integrated circuit chip is mounted on the substrate;
positioning and soldering a memory chip onto the substrate after the integrated circuit chip is soldered onto the first surface of the substrate; and
attaching a stiffening member to the substrate after the cladding is removably attached to the substrate.

2. The method of claim 1, further comprising:
moving the substrate into contact with a planar surface of the supporting member parallel to the substrate so that the substrate is encompassed by a first boundary area of the supporting member;
moving the substrate into contact with a planar surface of the clamping member parallel to the substrate so that the substrate is encompassed by a second boundary area of the clamping member; and
positioning the clamping member on the substrate so that the integrated chip is positioned within at least one of the plurality of openings, and the passive component and the memory chip are positioned within another one of the plurality of openings.

3. The method of claim 2, wherein a length and a width of the first boundary area is substantially equal in size to a length and a width of the second boundary area.

4. The method of claim 2, wherein the supporting member and clamping member comprise tool steel.

5. The method of claim 1, wherein soldering the integrated circuit chip comprises reflow soldering by heating the substrate to a first predetermined temperature, the method further comprising:
maintaining the cladding on the substrate for a predetermined period of time, wherein the predetermined period of time begins when the substrate reaches the first predetermined temperature and expires after the substrate reaches a second predetermined temperature, and wherein the first predetermined temperature is higher than the second predetermined temperature.

6. The method of claim 5, wherein applying the predetermined pressure comprises continuously applying the predetermined pressure for the duration of the predetermined period of time with the clamping member, and pressing the substrate against the supporting member with the clamping member to maintain as flat the substrate.

7. (canceled)

8. The method of claim 1, wherein the plurality of openings comprises a first opening and a second opening, and the method further comprises positioning the integrated circuit chip on the substrate within the first opening and positioning the memory chip on the substrate within the second opening.

9. (canceled)

10. The method of claim 1, further comprising coupling the supporting member by a hinge to the clamping member.

11.-16. (canceled)

17. A method comprising:
mounting a passive component onto a substrate of a system in package module, the substrate having a first surface and a second surface, the passive component mounted onto the first surface of the substrate;
attaching a cladding to the substrate for assembly of the system in package module after the passive component is mounted, wherein the cladding comprises:
a supporting member configured to set the second surface of the substrate thereon, and
a clamping member configured to hold the substrate parallel to the supporting member, the clamping member having a plurality of openings therein;
mounting an integrated circuit chip on the first surface of the substrate after the cladding is attached to the substrate, wherein the integrated circuit chip is positioned within at least one of the plurality of openings;
heating the substrate to a first predetermined temperature to solder the integrated circuit chip to the substrate;
positioning and soldering a memory chip onto the substrate within another one of the plurality of openings in the clamping member after the integrated circuit chip is attached to the substrate;
allowing the substrate to cool to a second predetermined temperature, wherein the second predetermined temperature is lower than the first predetermined temperature;
applying, for at least a predetermined period of time, a predetermined pressure on an external surface of the clamping member causing the clamping member to maintain as flat the substrate for the duration of the predetermined period of time, wherein the predetermined period of time begins when the substrate is heated to the first predetermined temperature and expires after the substrate cools to the second predetermined temperature;
attaching a stiffening member to the substrate after the cladding is removably attached to the substrate, the stiffening member having a plurality of cavities therein, and wherein the integrated circuit chip is positioned within at least one of the plurality of cavities and the memory chip is positioned within at least another one of the plurality of cavities; and
removing the cladding from the substrate when the first predetermined period of time expires.

18. The method of claim 17, further comprising:
moving the substrate into contact with a planar surface of the supporting member parallel to the substrate so that the substrate is encompassed by a first boundary area of the supporting member; and
moving the substrate into contact with a planar surface of the clamping member parallel to the substrate so that the substrate is encompassed by a second boundary area of the clamping member.

19. (canceled)

20. The method of claim 17, wherein the plurality of openings comprises a first opening and a second opening, and the method further comprises positioning the integrated circuit chip on the substrate within the first opening and positioning the memory chip on the substrate within the second opening; and the method further comprising:
removing the cladding from the substrate after the memory chip is positioned onto the substrate.

21. The method of claim 1, further comprising removing the cladding from the substrate before the memory chip is p onto the substrate, and wherein the clamping member is further configured to maintain as flat the substrate by pressing the substrate against the supporting member, and wherein the integrated circuit chip is soldered onto the first surface of the substrate during the predetermined period of time.

22. The method of claim 21, further comprising:
positioning and soldering a plurality of additional memory chips onto the substrate, wherein the plurality of openings comprises:
a first opening formed to receive the integrated circuit chip, which is positioned within the first opening during the predetermined period of time, and
a plurality of memory chip openings each formed to receive a memory chip; and
positioning each additional memory chip within the plurality of memory chip openings and soldering the memory chip onto the substrate during the predetermined period of time.

23. The method of claim 1, wherein the stiffening member is attached to the substrate after the cladding is removed.

24. The method of claim 1, wherein the stiffening member is attached to the substrate before the cladding is removed, and the stiffening member has a thickness that extends away from the first surface to a height that is sufficient to protect the passive component, the integrated circuit chip, and the memory chip.

25. The method of claim 1, further comprising applying an underfill between the integrated circuit chip and the first surface of the substrate after the integrated circuit chip is soldered to the substrate; and wherein the memory is soldered onto the substrate before the cladding is removed.

26. The method of claim 1, wherein the predetermined pressure is substantially uniform across the external surface of the clamping member and applied by a mechanical press or a hydraulic press.

27. The method of claim 17, wherein the predetermined pressure is substantially uniform across the external surface of the clamping member and applied by a mechanical press or a hydraulic press.

28. The method of claim 17, wherein the stiffening member is attached to the substrate after the cladding is removed.

29. The method of claim 17, wherein the stiffening member is attached to the substrate before the cladding is removed.
